(19) United States
(12) Patent Application Publication
(10) Pub. No.: US 2007/0200388 A1
(43) Pub. Date: Aug. 30, 2007

(54) On-Board Auxiliary Hydraulic Systems

(76) Inventors: Nikesh Bakshi, Granger, WI (US); Victor Wen, Mishawaka, IN (US)

Correspondence Address: QUARLES & BRADY LLP, 411 E. WISCONSIN AVENUE, SUITE 2040, MILWAUKEE, WI, 53202-4497, US

(21) Appl. No.: 11/557,719

(22) Filed: Nov. 8, 2006

Related U.S. Application Data
(60) Provisional application No. 60/777,642, filed on Feb. 28, 2006.

(51) Int. Cl. B60R 15/00

(52) U.S. Cl. 296/156

(57) ABSTRACT

The power steering pump of a vehicle powers an auxiliary hydraulic system of the vehicle only when the vehicle is parked.

### CROSS-REFERENCE TO RELATED APPLICATION

This claims the benefit of U.S. Provisional Patent Application No. 60/777,642 filed Feb. 28, 2006.

### STATEMENT CONCERNING FEDERALLY SPONSORED RESEARCH OR DEVELOPMENT

Not applicable.

### FIELD OF THE INVENTION

This invention relates to vehicle mounted auxiliary hydraulic systems like hydraulic powered jacks, extendible legs and slide-outs that use the vehicle engine driven hydraulic pump that is normally used for power steering or power brakes of the vehicle to drive the auxiliary hydraulic systems.

### BACKGROUND OF THE INVENTION

A common method to actuate hydraulic devices in RVs (recreational vehicles), trucks, convertibles with hydraulic top mechanisms and other vehicles with auxiliary hydraulic mechanisms is to provide a hydraulic power unit consisting of an electric motor, pump, reservoir and manifold with appropriate switching and valving mechanisms. A power unit, such as the one described above, is used in RVs to actuate leveling legs, slide-outs or other on-board auxiliary hydraulic systems. A similar power unit is used for actuating legs on a semi-trailer, or operating hydraulic cylinders in a garbage truck. These are auxiliary, because they are systems that are not part of the vehicle that are engine powered and used during over the road travel of the vehicle, like the power brakes and power steering.

### SUMMARY OF THE INVENTION

A new design of hydraulic system harnesses the oil pressure generated by the on-board hydraulic pump in an engine to actuate the auxiliary hydraulic devices of the vehicle. Vehicle engines have hydraulic pumps that are used to drive power steering, power brakes, etc. that are used for over-the-road operation of the vehicle and are not auxiliary. In the invention, this pump is used to power the auxiliary hydraulic system, but only when the vehicle is parked.

When the vehicle engine is running, but the vehicle is not moving, oil pressure is being generated by the on-board pump that is not needed. This system uses the oil pressure and diverts the flow to actuate auxiliary hydraulic devices when the vehicle is parked.

In RV applications to actuate room slides, leveling legs, step-slides, generator slides, etc., this saves the cost of a pump, weight of the pump, reduced mounting time, and reduced electrical power harnesses. In class-8 trucks, this device can be mounted on the truck and the semi-trailer will have the hydraulically powered legs. Through quick-connects for hydraulic and electrical lines, the semi-trailer can be actuated from the truck engine pump. The invention could also be applied to other vehicles, such as a dump truck lift, a garbage truck, a trash truck lift or a hydraulically operated convertible top, door, hatch or trunk for an automobile.

In one aspect, the system gets electronic signals from the vehicle for the parking brake ‘engaged’ and gear in ‘neutral/park’, and only then diverts the flow from the on-board hydraulic pump for use in auxiliary hydraulic devices.

In another aspect, the return line of the new system goes through a separate oil filter at low pressure, for cleaning out any impurities, before returning oil to the vehicle engine driven pump system.

In another aspect, the flow rate of the on-board pump may be high, for example up to 10 g.p.m., and the new system manifold uses a set of regulating valves to control the speed of actuation and desired pressure into the auxiliary hydraulic devices to accommodate such a system.

In another aspect, a hydraulic fluid level sensor in the reservoir detects when the fluid level is too low and alerts the operator to check it.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is an electro-hydraulic schematic of an on-board vehicle hydraulic system of the invention.

### DETAILED DESCRIPTION OF THE PREFERRED EMBODIMENT

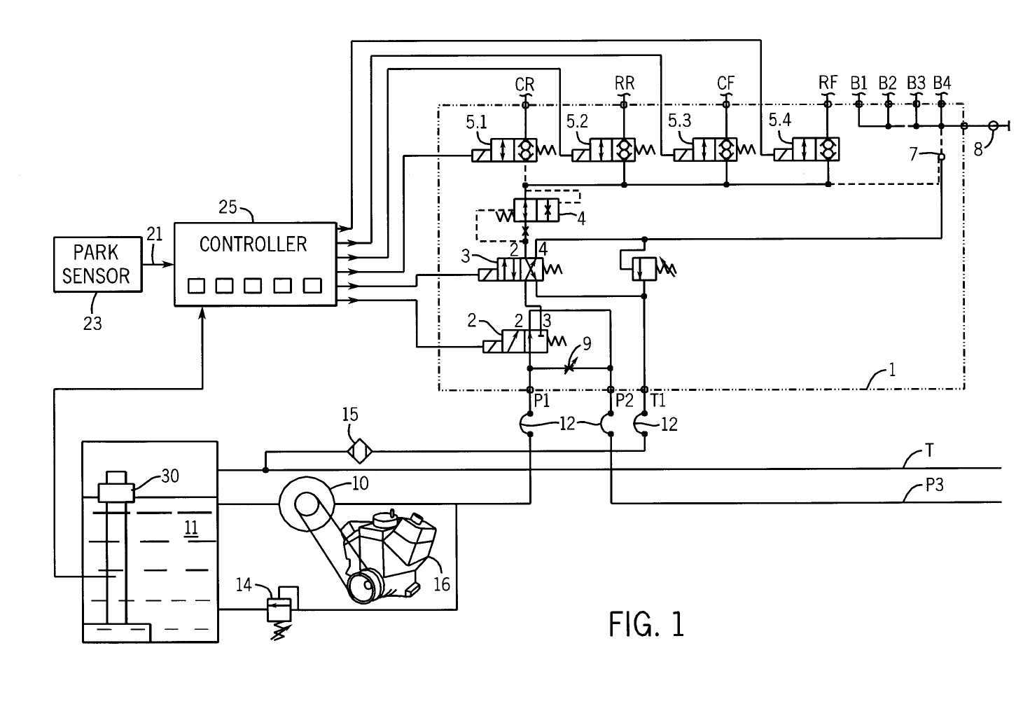

Referring to FIG. 1, components of a preferred embodiment of an on-board hydraulic system of the invention are the vehicle engine driven power steering pump 10, typically driven by a belt from the crankshaft pulley of the vehicle engine 16 that is used for driving the wheels of the vehicle, a reservoir 11 and a pressure relief valve 14. Most on-board systems have an oil-filter 15, sometimes in the return line as illustrated and sometimes inside the reservoir 11. ‘P’ represents a hydraulic line, which could be a hose under pressure, and ‘T’ represents the low-pressure return line going into the reservoir 11. The pump 10 provides fluid under pressure to the power steering, power brakes, or other vehicle running gear systems (not shown except for line P3 and line T extending to the right) of the vehicle in usual fashion when the vehicle is in transit.

The new system consists of an auxiliary hydraulic system including a hydraulic manifold 1, the hydraulic circuit of which is shown in FIG. 1. Parts not shown are hoses, fittings, hydraulic cylinders, for example of an RV slide-out system (reference U.S. Pat. No. 5,758,918 which is hereby incorporated by reference for its disclosure in FIGS. 13 and 14 and the accompanying description of a hydraulic slide-out system) or of a leveling system (reference U.S. Pat. No. 5,312,119, which is hereby incorporated by reference for its disclosure of a hydraulically operated leveling system) that need to be actuated and an electrical harness.

CR, RR, CF and RF represent the pressure or bore side of cylinders that need to be actuated. There can be fewer or more cylinders actuated using this technique depending upon the need. Valves 5.1, 5.2, 5.3 and 5.4 are directional valves that direct flow to the cylinders. B1, B2, B3 and B4 are return (rod side) lines from the cylinders.

Directional valve 2 determines whether the oil under pressure goes to auxiliary hydraulic devices or continues to flow to the vehicle running gear systems such as the power steering circuit, which is supplied by line P3. Valve 2 is actuated to direct fluid from the pump to the auxiliary systems only when the vehicle is parked.

Directional valve 3 determines whether the auxiliary hydraulic cylinders extend or retract. Flow regulator 4 restricts the flow depending upon need. Relief valve 6 limits the speed at which the cylinders retract. Pilot operated check valve (POCV) 7 holds the cylinders in extend position. A return line oil filter 15 cleans the oil before being dumped into the reservoir 11. 12 represents flexible hoses and fittings to connect to the manifold. An optional needle valve 9 or an orifice can be provided to bypass the excessive pump flow to line P3.

A fluid level sensor 30 is provided in the reservoir 11 that detects the fluid level and if too low, gives a signal to the controller 25. The controller 25 upon detecting the signal generates an audible and/or visual warning to the operator that the hydraulic fluid level is low and should be checked.

In the normal condition, the vehicle is moving (in transit) and the auxiliary hydraulic circuit is not activated when valve 2 is not energized. In this condition, hydraulic fluid under pressure bypasses the manifold and flows directly to line P3, which operates normally to energize power steering or other vehicle running gear hydraulic systems that are operated while the vehicle is being driven.

When the vehicle is parked, and with the engine 16 running, the auxiliary hydraulic system can be activated. If the vehicle has a manual transmission, the transmission is shifted into neutral and the parking brake is applied. If it has an automatic transmission, the transmission is placed in “Park” and the parking brake may or may not be applied. All of these conditions can be sensed with simple electrical sensors or switches, and typical vehicles are provided with such sensors such that electrical outputs indicating the state of the parking brake and transmission, whether automatic or manual, are well known such that it can be readily sensed if the vehicle is parked. Only when that is the case, i.e., the vehicle is parked, can valve 2 be energized by the operator of the auxiliary hydraulic system so as to activate the auxiliary system.

During extending of the hydraulic cylinders, valves 2, 3, 5.1, 5.2, 5.3, 5.4 are energized and oil goes into the cap or bore end of the cylinders and they extend. The extend speed can be regulated by valve 4. The excess capacity of the pump 10 bypasses to reservoir 11 using by-pass valves 9 and 14.

To retract the hydraulic cylinders, valves 2, 5.1, 5.2, 5.3 and 5.4 are energized and oil under pressure comes from the pump goes through valve 7 to the rod end of the hydraulic cylinders. The cylinders start retracting and fluid from the cap end of the cylinders is pushed through the valves 5.1, 5.2, 5.3, 5.4 and valves 3, 4 and filter 15 and returns to reservoir 11. Valve 4 controls the speed of retract and valve 6 regulates the pressure of the cylinders.

A preferred embodiment of the invention has been described in considerable detail. Many modifications and variations to the preferred embodiment described will be apparent to a person of ordinary skill in the art. Therefore, the invention should not be limited to the embodiment described.

We claim:

1. In an auxiliary hydraulic system for a vehicle that is operable to actuate one or more auxiliary hydraulic devices on board the vehicle that are only operable when the vehicle is not being driven, the vehicle having an engine that is engageable with wheels of the vehicle to propel the vehicle and a hydraulic power steering pump that is driven by the engine and supplies fluid under pressure to a power steering system of the vehicle when the vehicle is in transit, the improvement wherein the power steering pump provides a source of hydraulic fluid under pressure to power the auxiliary hydraulic system and is operable to power said system only when the vehicle is parked.

2. The improvement of claim 1, wherein the system senses whether the vehicle is parked by determining if it is in neutral with the parking brake on.

3. The improvement of claim 1, wherein the vehicle has an automatic transmission and the system senses whether the vehicle is parked by determining if the transmission is in park.

4. The improvement of claim 1, wherein the system is a vehicle leveling system.

5. The improvement of claim 1, wherein the system is a slide-out system.

6. The improvement of claim 1, wherein the vehicle is a recreational vehicle.

7. The improvement of claim 1, wherein when the vehicle is parked the power steering pump does not provide fluid under pressure to the power steering system unless there is excessive flow from the pump that is not needed by the auxiliary hydraulic system.

8. The improvement of claim 1, wherein the auxiliary hydraulic system has a return line that is separate from a return line of the power steering system.

9. The improvement of claim 1, wherein the system alerts the operator of a low volume of hydraulic fluid in the system.
